(19) United States
(12) Patent Application Publication
(10) Pub. No.: US 2023/0187671 A1
(43) Pub. Date: Jun. 15, 2023

(54) STRUCTURE FOR IMPROVING PERFORMANCE OF FUEL CELL THERMAL MANAGEMENT SYSTEM

(71) Applicants: Hyundai Motor Company, Seoul (KR); Kia Corporation, Seoul (KR)

(72) Inventor: Oh Tak Kwon, Yongin (KR)

(21) Appl. No.: 17/987,589

(22) Filed: Nov. 15, 2022

(30) Foreign Application Priority Data
Dec. 13, 2021 (KR) 10-2021-0177182

(51) Int. Cl. H01M 8/04746; H01M 8/04029; H01M 8/04007; H01M 8/04302; H01M 8/04225; H01M 8/04044; H01M 8/04701; H01M 8/0432; H01M 8/2483

(52) U.S. Cl. CPC H01M 8/04768; H01M 8/0432; H01M 8/2483; H01M 8/04029; H01M 8/04037; H01M 8/04044; H01M 8/04074; H01M 8/04225; H01M 8/04302; H01M 8/04723; B60L 58/32; H01M 2250/20

(57) ABSTRACT

An embodiment of the present disclosure provides a structure for improving performance of a fuel cell thermal management system. The structure for improving performance of a fuel cell thermal management system may comprise a radiator configured to exchange heat with a coolant discharged from a fuel cell stack, a coolant supply pump configured to supply the coolant to the fuel cell stack, a cathode oxygen depletion (COD) heater disposed in parallel with the radiator, a heater core disposed in series with the COD heater and configured to heat an interior of a vehicle, a temperature adjustment valve coupled to the radiator, the coolant supply pump, and the heater core and configured to control a flow of the coolant, and a reservoir disposed between a downstream side of the fuel cell stack and a front end of the coolant supply pump and configured to adjust a pressure of the coolant.

### CROSS-REFERENCE TO RELATED APPLICATION(S)

This application claims, under 35 U.S.C. §119(a), the benefit of Korean Patent Application No. 10-2021-0177182, filed on Dec. 13, 2021, the disclosure of which is incorporated herein by reference in its entirety.

### BACKGROUND

### Technical Field

Embodiments of the present disclosure relate to a structure for improving performance of a fuel cell thermal management system, which is capable of improving heating performance of the fuel cell thermal management system and controlling a pressure of a coolant.

### Background

A fuel cell stack, which is a main component of a fuel cell system, refers to a power generation device that generates electrical energy through a chemical reaction between oxygen contained in air and hydrogen supplied from the outside. The fuel cell system includes the fuel cell stack configured to generate electrical energy through an electrochemical reaction between reactant gases (hydrogen, which is fuel, and oxygen which is an oxidant), a hydrogen supply device configured to supply hydrogen, which is fuel, to the fuel cell stack, an air supply device configured to supply air containing oxygen to the fuel cell stack, a fuel cell thermal management system configured to control an operating temperature of the fuel cell stack and perform a function of managing a coolant, and a fuel cell controller configured to control an overall operation of the fuel cell system.

The fuel cell thermal management system in the existing technologies cannot control a pressure of the coolant at normal times in a heating mode. This is because a coolant circulation circuit does not include a reservoir in the heating mode in some instances. If the coolant does not circulate to the reservoir in the heating mode, an internal pressure of the fuel cell stack may excessively increase and cavitation may occur in a pump. In a long-term point of view, these problems have significantly adverse effects on durability of the fuel cell thermal management system. In a severe case, there occurs a breakdown of the system such as damage to a pump impeller or failure in maintaining sealability of a separator of the fuel cell stack.

In addition, the coolant does not circulate to a COD heater and a heater core during the cold start of the fuel cell thermal management system, which hinders heating an interior using coolant waste heat.

In addition, in the fuel cell thermal management system in the existing technologies, the fuel cell stack and the COD heater and the heater core to heat the interior are connected in parallel, and the coolant discharged from the fuel cell stack cannot flow only to the COD heater and the heater core. Therefore, the coolant also flows to a radiator in the heating mode, such that the heater core cannot exhibit maximum performance.

The above information disclosed in this Background section is only for enhancement of understanding of the background of the disclosure and therefore it may contain information that does not form the existing technologies that is already known in this country to a person of ordinary skill in the art.

### SUMMARY

The present disclosure has been made in an effort to solve the above-described problems associated with prior art.

An object of the present disclosure is to provide a structure for improving performance of a fuel cell thermal management system, which is capable of improving heating performance of the fuel cell thermal management system and controlling a pressure of a coolant.

Another object of the present disclosure is to provide a structure for improving performance of a fuel cell thermal management system, which is capable of maintaining performance in heating a vehicle interior even during a cold start of the fuel cell thermal management system.

In one aspect, the present disclosure provides a structure for improving performance of a fuel cell thermal management system. The structure for improving performance of a fuel cell thermal management system includes: a radiator configured to exchange heat with a coolant discharged from a fuel cell stack; a coolant supply pump configured to supply the coolant to the fuel cell stack; a COD heater disposed in parallel with the radiator; a heater core disposed in series with the COD heater and configured to heat an interior of a vehicle; a temperature adjustment valve coupled to the radiator, the coolant supply pump, and the heater core and configured to control a flow of the coolant; and a reservoir disposed between a downstream side of the fuel cell stack and a front end of the coolant supply pump and configured to adjust a pressure of the coolant.

In a preferred embodiment, the temperature adjustment valve may be configured to restrict a flow of the coolant to the radiator and allow the coolant to flow to the COD heater and the heater core during a cold start of the fuel cell thermal management system.

In another preferred embodiment, the structure may further comprise a stack bypass valve disposed between an upstream side of the fuel cell stack and the coolant supply pump; and an ion filter disposed between the stack bypass valve and the downstream side of the fuel cell stack.

In still another preferred embodiment, the stack bypass valve may be configured to prevent the coolant from flowing to the fuel cell stack and allow the coolant to flow to the ion filter during a cold start of the fuel cell thermal management system.

In yet another preferred embodiment, the stack bypass valve prevents the coolant from flowing to the ion filter in a heating mode of the fuel cell thermal management system.

In still yet another preferred embodiment, the temperature adjustment valve may be configured to prevent the coolant discharged from the fuel cell stack to flow to the heater core and the COD heater and allow the coolant to flow to the radiator in a high output mode of the fuel cell thermal management system.

In a further preferred embodiment, a part of the coolant discharged from the fuel cell stack may flow to the reservoir at normal times.

In another further preferred embodiment, the temperature adjustment valve may be configured to prevent the coolant from flowing to the radiator and allow the coolant discharged from the fuel cell stack to flow to the COD heater and the heater core in a heating mode of the fuel cell thermal management system.

In still another further preferred embodiment, the structure may further comprise a controller configured to calculate available heating power in a heating mode of the fuel cell thermal management system on the basis of a target temperature of the interior of the vehicle inputted by a user and a temperature measured by temperature sensors respectively disposed at upstream and downstream sides of the fuel cell stack.

In yet another further preferred embodiment, the controller may compare a current temperature of the interior of the vehicle with the target temperature, and when the current temperature of the interior is equal to or higher than the target temperature, the controller may be configured to end the heating mode of the fuel cell thermal management system by stopping operations of the COD heater and the heater core.

In still yet another further preferred embodiment, when a current temperature of the interior of the vehicle is lower than the target temperature, the controller may be configured to monitor a temperature at an inlet of the fuel cell stack, and when the temperature at the inlet of the fuel cell stack is equal to or higher than a preset temperature, the controller may be configured to increase a temperature of the coolant by controlling the COD heater.

In a still further preferred embodiment, the controller may be configured to increase the temperature of the coolant to be discharged from the fuel cell stack by controlling the fuel cell stack to generate an exceeding amount of electric power.

In a yet still further preferred embodiment, the structure may further comprise an ion filter disposed on a line branching off between an upstream side of the fuel cell stack and the coolant supply pump and coupled to the temperature adjustment valve.

In another further preferred embodiment, an inlet manifold may be disposed at the upstream side of the fuel cell stack, an outlet manifold may be disposed at a downstream side of the fuel cell stack, and the inlet manifold may be configured to distribute the coolant, which is supplied from the coolant supply pump, to the ion filter or the fuel cell stack.

In still another further preferred embodiment, an inlet manifold may be disposed at an upstream side of the fuel cell stack, an outlet manifold may be disposed at a downstream side of the fuel cell stack, and the outlet manifold may be configured to distribute the coolant to the reservoir, the COD heater, and the radiator.

According to the embodiment of the present disclosure, the COD heater and the heater core may be disposed in parallel with the radiator, such that the temperature adjustment valve may be configured to control the flow rate of the coolant flowing to the COD heater and the radiator.

According to the embodiment of the present disclosure, since the flows of the coolant flowing from the fuel cell stack to the heater core are connected in series, the heating amount may be increased by the high-temperature coolant discharged from the fuel cell stack, and the flow rate of the coolant flowing to the heater core may be ensured.

According to the fuel cell thermal management system according to the embodiment of the present disclosure, the coolant may be configured to flow to the reservoir at normal times, and the reservoir may be coupled to the inlet of the coolant supply pump, thereby preventing the occurrence of cavitation in the coolant supply pump and the breakdown caused by the increase in internal pressure of the fuel cell stack.

According to the embodiment of the present disclosure, the heating may be performed by the heater core even in the cold start mode of the fuel cell thermal management system. In addition, it is possible to perfectly utilize waste heat of the high-temperature coolant discharged from the fuel cell stack without a loss of the flow rate of the coolant flowing to the heater core.

Other aspects and preferred embodiments of the disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view illustrating a fuel cell thermal management system according to an embodiment of the present disclosure;

FIG. 2 is a view illustrating a flow of the coolant during a cold start of the fuel cell thermal management system according to the embodiment of the present disclosure;

FIG. 3 is a view illustrating a flow of the coolant in a heating mode of the fuel cell thermal management system according to the embodiment of the present disclosure;

FIG. 4 is a view illustrating a flow of the coolant in a high output mode of the fuel cell thermal management system according to the embodiment of the present disclosure;

FIG. 5 is a flowchart illustrating a method of improving heating performance of the fuel cell thermal management system according to the embodiment of the present disclosure; and

FIG. 6 is a view illustrating a modified example of the fuel cell thermal management system according to the embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between,”, “directly between,”, “adjacent to,”, or “directly adjacent to” should be construed in the same way.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

In addition, in the present specification, names of constituent elements are classified as a first ..., a second ..., and the like so as to discriminate the constituent elements having the same name, and the names are not essentially limited to the order in the description below.

The detailed description exemplifies the present disclosure. Further, the foregoing description merely shows and describes the exemplary embodiments of the present disclosure, and the present disclosure can be used in various other combinations, modifications, and environments. That is, alterations or modifications may be made within the scope of the concept of the disclosure disclosed in the present specification, the scope equivalent to the described disclosure, and/or the scope of the technology or knowledge in the art. The disclosed embodiments are provided to explain the best state for implementing the technical spirit the present disclosure, and various modifications required for the specific fields of application and the use of the present disclosure may be made. Thus, the detailed description of the present disclosure is not intended to limit the present disclosure to the disclosed embodiments. Moreover, the appended claims should be construed to include other embodiments.

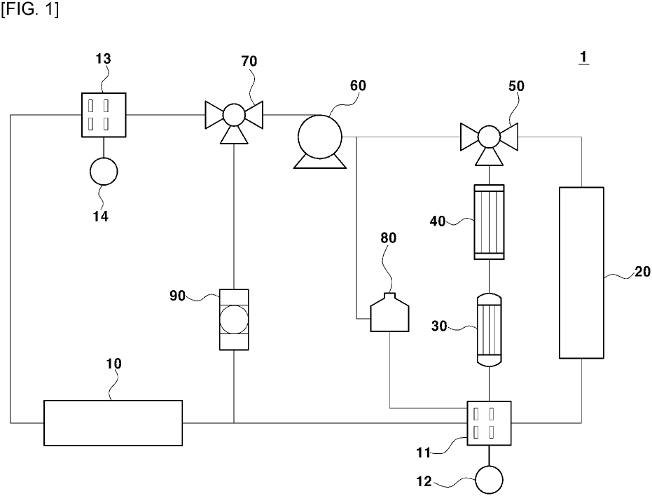

FIG. 1 is a view illustrating a fuel cell thermal management system according to an embodiment of the present disclosure.

Referring to FIG. 1, a fuel cell thermal management system 1 may comprise a fuel cell stack 10, a radiator 20, a cathode oxygen depletion (COD) heater 30, a heater core 40, a temperature adjustment valve 50, a coolant supply pump 60, a stack bypass valve 70, a reservoir 80, and an ion filter 90.

The fuel cell stack 10 may be configured to receive air and hydrogen and generate electric power through a chemical reaction between air and hydrogen. A coolant may be configured to flow into the fuel cell stack 10 to discharge heat which is a by-product generated by the chemical reaction in the fuel cell stack 10.

An outlet manifold 11 may be provided in an outlet of the fuel cell stack 10, and an inlet manifold 13 may be provided in an inlet of the fuel cell stack 10. Temperature sensors 12 and 14 may be disposed in the inlet and the outlet of the fuel cell stack 10 and measure temperatures of the coolant when the coolant is introduced into or discharged from the fuel cell stack 10. The temperature sensors 12 and 14 may comprise a first temperature sensor 12 configured to measure a temperature of the coolant discharged from the fuel cell stack 10, and a second temperature sensor 14 configured to measure a temperature of the coolant introduced into the fuel cell stack 10.

After the chemical reaction in the fuel cell stack 10, the radiator 20 may be configured to cool the heated coolant again. The coolant distributed in the outlet manifold 11 may be introduced into the radiator 20. The radiator 20 may be configured to discharge heat of the coolant to outside air. The coolant cooled by the radiator 20 may be configured to flow to the temperature adjustment valve 50.

The COD heater 30 heats the coolant when the coolant needs to be heated. The COD heater 30 may be configured to consume electric power, which is generated in the fuel cell stack 10, as heat in order to lower voltage of the fuel cell stack 10. The coolant distributed in the outlet manifold 11 may be introduced into the COD heater 30. In the fuel cell thermal management system 1, the COD heater 30 may be configured to increase the temperature of the coolant, and the coolant with the temperature increased by the COD heater 30 may be introduced into the heater core 40.

The heater core 40 may be configured to transfer the heat of the coolant to an air conditioning device (not illustrated) to heat the interior of the vehicle. The heater core 40 may be disposed at a rear end of the COD heater 30. Specifically, the heater core 40 may be disposed between the COD heater 30 and the temperature adjustment valve 50. A temperature at an inlet of the heater core 40 may be affected by an output of the COD heater 30. The coolant with the temperature increased by the COD heater 30 may be configured to increase the heating amount by the heater core 40. That is, as the heater core 40 increases the temperature of the coolant, the heater core 40 may be configured to transfer higher heat to the air conditioning device (not illustrated).

The COD heater 30 and the heater core 40 may be disposed in series. The COD heater 30 and the heater core 40 may be disposed in parallel with the radiator 20.

The temperature adjustment valve 50 may be coupled to the radiator 20, the coolant supply pump 60, and the heater core 40 and control a flow of the coolant. The temperature adjustment valve 50 may be configured to allow the coolant introduced from the radiator 20 or the heater core 40 to flow to the coolant supply pump 60. For example, the temperature adjustment valve 50 may be a 3-way valve. The temperature adjustment valve 50 may be configured to allow the coolant to flow to the radiator 20 and/or the COD heater 30, and the temperature of the coolant may vary depending on a direction in which the coolant flows. The temperature adjustment valve 50 may be configured to distribute the coolant while adjusting flow rates of the coolant to be introduced into the radiator 20 and the COD heater 30. For example, the temperature of the coolant may be increased when the coolant flows to the COD heater 30, and the temperature of the coolant may be decreased when the coolant flows to the radiator 20.

The coolant supply pump 60 may be configured to supply the stack bypass valve 70 with the coolant transmitted from the temperature adjustment valve 50. The coolant supply pump 60 may be configured to control the flow rate of the coolant.

The stack bypass valve 70 may be disposed between an upstream side of the fuel cell stack 10 and the coolant supply pump 60. The stack bypass valve 70 may be configured to distribute the coolant, which is supplied from the coolant supply pump 60, to the fuel cell stack 10 and the ion filter 90. Specifically, the stack bypass valve 70 may be configured to distribute the flow rate of the coolant to the inlet manifold 13 in order to supply the coolant to the fuel cell stack 10. For example, the stack bypass valve 70 may be a 3-way valve.

The reservoir 80 may be configured to adjust a pressure of the coolant in the fuel cell thermal management system 1. The reservoir 80 may be configured to store the coolant to adjust the pressure of the coolant. The reservoir 80 may be disposed between a downstream side of the fuel cell stack 10 and a front end of the coolant supply pump 60. The reservoir 80 may be disposed in parallel with the radiator 20. The coolant may be supplied to the reservoir 80 through the outlet manifold 11. Since the reservoir 80 is independently disposed at a downstream side of the outlet manifold 11, the coolant with the temperature increased by the fuel cell stack 10 may be introduced into the reservoir 80.

A part of the coolant discharged from the fuel cell stack 10 may be introduced into the reservoir 80 at normal times. However, a port of the outlet manifold 11, which is provided to allow the coolant to flow to the reservoir 80, may be smaller in diameter than a port of the outlet manifold 11 which is provided to allow the coolant to flow to the radiator 20 or the COD heater 30. Therefore, a flow rate of the coolant to be supplied to the reservoir 80 from the outlet manifold 11 may be lower than a flow rate of the coolant to be supplied to the radiator 20 or the COD heater 30. The reservoir 80 may be configured to adjust the pressure of the coolant in advance to prevent the occurrence of cavitation in the coolant supply pump 60 and prevent the pressure in the fuel cell stack 10 from exceeding a preset internal pressure. The cavitation means a phenomenon in which impactive noise or erosion occurs when bubbles, which are generated in a high-speed, low-pressure part in the coolant supply pump 60, are eliminated by flowing to a high-pressure part. The performance of the coolant supply pump 60 may deteriorate or the coolant supply pump 60 may be damaged because of the cavitation in the coolant supply pump 60. For this reason, the durability of the fuel cell stack 10 may deteriorate because of a successive decrease in cooling flow rate in the fuel cell stack 10 and because of the occurrence of a hot spot caused by an increase in temperature of a cell membrane. The reservoir 80 according to the embodiment of the present disclosure is in direct contact with the inlet of the coolant supply pump 60, which makes it possible to control the pressure of the coolant to be supplied to the coolant supply pump 60, remove bubbles of the coolant, and thus prevent the occurrence of cavitation in the coolant supply pump 60.

The ion filter 90 may be configured to remove ions contained in the coolant. The ion filter 90 may be configured to remove the ions contained in the coolant provided by the coolant supply pump 60, and the coolant from which the ions are removed may be supplied to the outlet manifold 11.

According to the embodiment of the present disclosure, the COD heater 30 and the heater core 40 may be disposed in parallel with the radiator 20, such that the temperature adjustment valve 50 may be configured to control the flow rate of the coolant flowing to the COD heater 30 and the radiator 20. In addition, the coolant discharged from the fuel cell stack 10 may be introduced only into the COD heater 30 and the heater core 40 under the control of the temperature adjustment valve 50, such that the heater core 40 may be configured to use waste heat of the high-temperature coolant discharged from the fuel cell stack 10.

According to the embodiment of the present disclosure, since the flows of the coolant flowing from the fuel cell stack 10 to the heater core 40 are connected in series, the heating amount may be increased by the high-temperature coolant discharged from the fuel cell stack 10, and the flow rate of the coolant flowing to the heater core 40 may be ensured.

According the fuel cell thermal management system 1 according to the embodiment of the present disclosure, the coolant may be configured to flow to the reservoir 80 at normal times, and the reservoir 80 may be coupled to the inlet of the coolant supply pump 60, thereby preventing the occurrence of cavitation in the coolant supply pump 60 and the breakdown caused by the increase in internal pressure of the fuel cell stack 10.

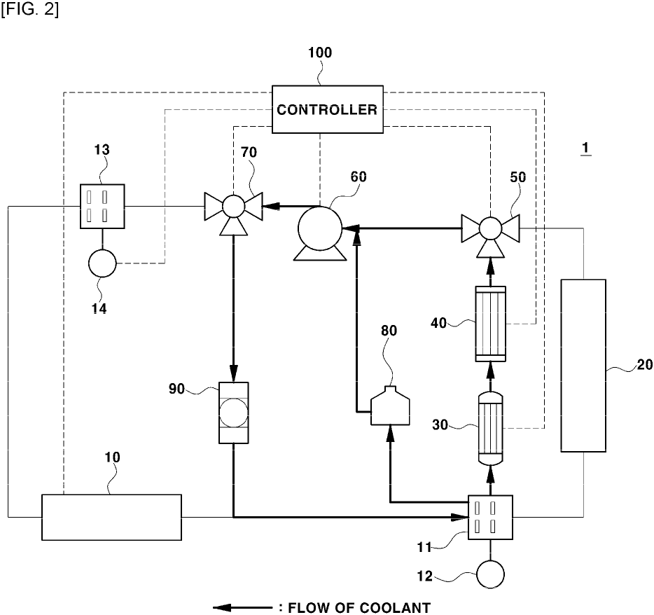

FIG. 2 is a view illustrating a flow of the coolant during a cold start of the fuel cell thermal management system according to the embodiment of the present disclosure.

Referring to FIG. 2, a controller 100 may be provided to control the fuel cell stack 10, the COD heater 30, the heater core 40, the temperature adjustment valve 50, the coolant supply pump 60, and the stack bypass valve 70. For example, the controller 100 may include a processor or Electronic Control Unit (ECU). The controller 100 may be configured to collect the temperatures of the coolant, which affect the heating amount by the heater core 40, from the first temperature sensor 12 and the second temperature sensor 14. The controller 100 may be configured to collect a vehicle speed and an outside air temperature to calculate properties of air introduced into the vehicle by a blower (not illustrated) that operates in conjunction with the heater core 40. The controller 100 may be configured to collect an output state of the fuel cell stack 10 and a current interior temperature in the vehicle. The controller 100 may be configured to calculate available heating power on the basis of the acquired information. Within a range of the available heating power, the controller 100 may be configured to control the power generation amount of the fuel cell stack 10, the operation amount of the COD heater 30, and the rotational speed of the blower (not illustrated) that operates in conjunction with the heater core 40.

The fuel cell thermal management system 1 may be configured to control a flow direction of the coolant, a flow rate of the coolant, and the like depending on an operating condition of the vehicle. Specifically, the fuel cell thermal management system 1 may be configured to control and change the flow direction of the coolant depending on a cold start mode of the fuel cell stack 10 and a high output mode and a heating mode of the vehicle. However, the coolant may be introduced into the reservoir 80 at normal times regardless of the mode of the fuel cell thermal management system 1.

In the cold start mode of the fuel cell thermal management system 1, the temperature adjustment valve 50 may be configured to perform control to restrict the flow of the coolant to the radiator 20 and allow the coolant to flow to the COD heater 30 and the heater core 40. That is, in the cold start mode of the fuel cell thermal management system 1, the port of the temperature adjustment valve 50 coupled to the radiator 20 may be closed by the controller 100, and the port of the temperature adjustment valve 50 coupled to the COD heater 30 may be opened by the controller 100. In this case, a small amount of coolant may be configured to flow from the outlet manifold 11 to the reservoir 80.

The stack bypass valve 70 may be configured to allow the coolant, which is supplied from the coolant supply pump 60, to flow to the ion filter 90. That is, in the cold start mode of the fuel cell thermal management system 1, the port of the stack bypass valve 70 coupled to the inlet manifold 13 of the fuel cell stack 10 may be closed by the controller 100, and the port of the stack bypass valve 70 coupled to the ion filter 90 may be opened by the controller 100. Therefore, the coolant may not be introduced into the fuel cell stack 10 during the cold start. In addition, since the coolant is introduced into the COD heater 30 and the heater core 40 even during the cold start, the heating may be performed by the activation of the air conditioning device. That is, the COD heater 30 may be configured to consume electric power generated by the fuel cell stack 10 and increase the temperature of the coolant supplied for consuming electric power. The heater core 40 may be configured to heat the vehicle interior through heat exchange between air and the coolant with the increased temperature.

According to the embodiment of the present disclosure, the heating may be performed by the heater core 40 even in the cold start mode of the fuel cell thermal management system 1. In addition, it is possible to perfectly utilize waste heat of the high-temperature coolant discharged from the fuel cell stack 10 without a loss of the flow rate of the coolant flowing to the heater core 40.

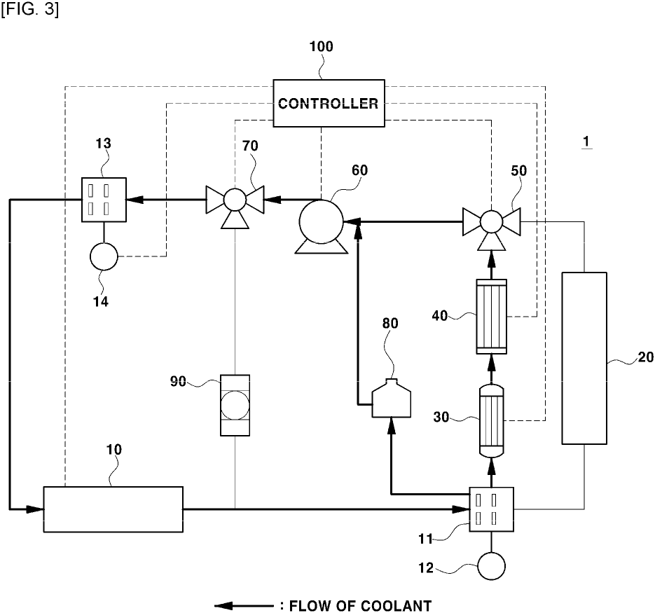

FIG. 3 is a view illustrating a flow of the coolant in the heating mode of the fuel cell thermal management system according to the embodiment of the present disclosure. For simplifying the description, a description of the contents identical to the contents described with reference to FIG. 2 will be omitted.

Referring to FIG. 3, in the heating mode of the fuel cell thermal management system 1, the temperature adjustment valve 50 may be configured to prevent the coolant from flowing to the radiator 20. That is, in the heating mode of the fuel cell thermal management system 1, the port of the temperature adjustment valve 50 coupled to the radiator 20 may be closed by the controller 100, and the port of the temperature adjustment valve 50 coupled to the COD heater 30 may be opened by the controller 100. The coolant discharged from the fuel cell stack 10 may be configured to flow to the COD heater 30 and the heater core 40. The stack bypass valve 70 may be configured to prevent the coolant from flowing to the ion filter 90. That is, in the heating mode of the fuel cell thermal management system 1, the port of the stack bypass valve 70 coupled to the inlet manifold 13 of the fuel cell stack 10 may be opened by the controller 100, and the port of the stack bypass valve 70 coupled to the ion filter 90 may be closed by the controller 100.

The coolant discharged from the fuel cell stack 10 may be introduced into the COD heater 30 without being distributed to the radiator 20. The heating amount by the heater core 40 may increase as the flow rate of the coolant to be introduced into the COD heater 30 may increase. In addition, the coolant, which has an increased temperature while passing through the fuel cell stack 10, may be introduced into the COD heater 30, thereby increasing heating efficiency.

A small amount of coolant may be configured to flow from the outlet manifold 11 to the reservoir 80. Even in the heating mode of the fuel cell thermal management system 1, the coolant may be introduced into the reservoir 80, which makes it possible to prevent the increase in internal pressure of the fuel cell stack 10 and the cavitation in the coolant supply pump 60 that may occur in the heating mode of the fuel cell thermal management system 1.

In the heating mode of the fuel cell thermal management system 1, the controller 100 may be configured to control the power generation amount of the fuel cell stack 10 and the operation amount of the COD heater 30 in order to improve the heating performance. The controller 100 may be configured to control the power generation amount of the fuel cell stack 10 and the operation amount of the COD heater 30 on the basis of a target temperature in the vehicle interior preset by a user, a current temperature in the vehicle interior, and a temperature at the inlet of the fuel cell stack 10.

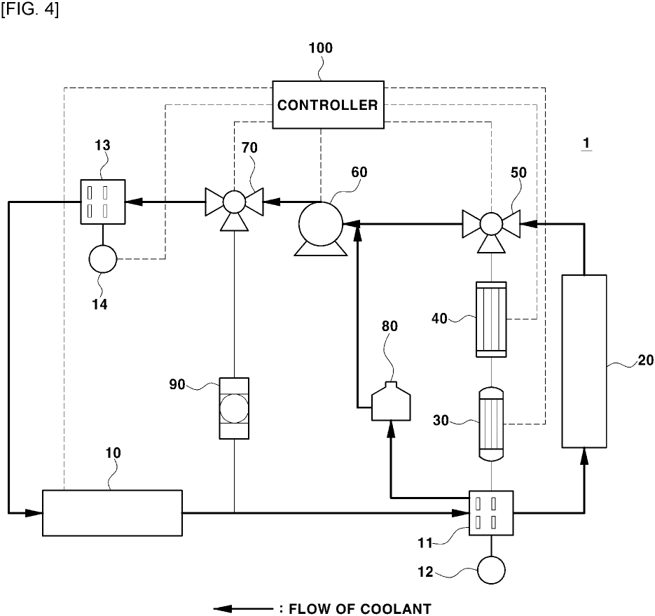

FIG. 4 is a view illustrating a flow of the coolant in the high output mode of the fuel cell thermal management system according to the embodiment of the present disclosure. For simplifying the description, a description of the contents identical to the contents described with reference to FIG. 2 will be omitted.

Referring to FIG. 4, in the high output mode of the fuel cell thermal management system 1, the temperature adjustment valve 50 may be configured to perform control to allow the coolant to flow to the radiator 20 while preventing the coolant discharged from the fuel cell stack 10 from flowing to the heater core 40 and the COD heater 30. That is, in the high output mode of the fuel cell thermal management system 1, the port of the temperature adjustment valve 50 coupled to the radiator 20 may be opened by the controller 100, and the port of the temperature adjustment valve 50 coupled to the COD heater 30 may be closed by the controller 100. In this case, a small amount of coolant may flow from the outlet manifold 11 to the reservoir 80. The high output mode of the fuel cell thermal management system 1 may mean a mode in which the power generation amount of the fuel cell stack 10 increases, and the coolant needs to be cooled. Therefore, the coolant discharged from the fuel cell stack 10 may be supplied to the radiator 20 and cooled without a loss of the flow rate. In this case, the controller 100 may be configured to control the coolant supply pump 60 and increase the flow rate of the coolant to be introduced into the fuel cell stack 10.

The stack bypass valve 70 may be configured to prevent the coolant from flowing to the ion filter 90. That is, in the high output mode of the fuel cell thermal management system 1, the port of the stack bypass valve 70 coupled to the inlet manifold 13 of the fuel cell stack 10 may be opened by the controller 100, and the port of the stack bypass valve 70 coupled to the ion filter 90 may be closed by the controller 100.

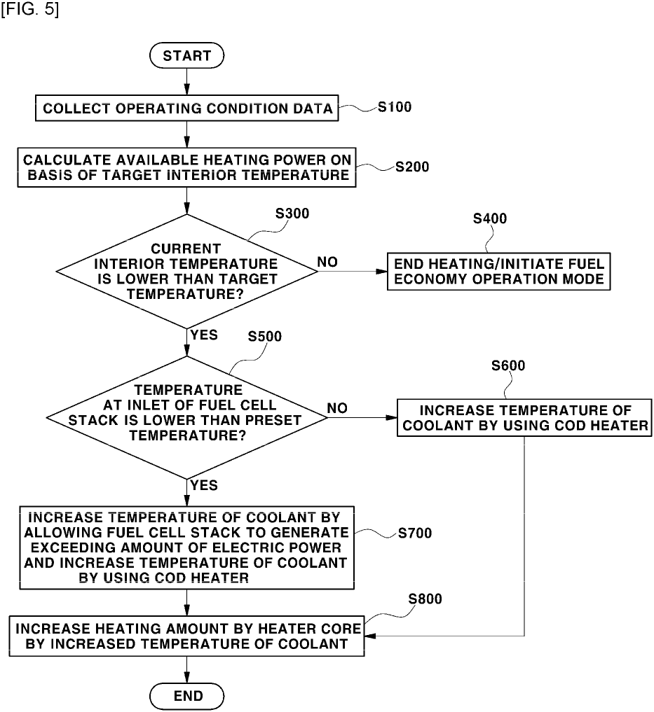

FIG. 5 is a flowchart illustrating a method of improving heating performance of the fuel cell thermal management system according to the embodiment of the present disclosure.

Referring to FIGS. 3 and 5, in the heating mode of the fuel cell thermal management system 1, the controller 100 may be configured to collect operating condition data to calculate electric power used to heat the vehicle interior in order to improve the heating performance. The operating condition data may comprise the temperature at the inlet of the fuel cell stack 10, the temperature at the outlet of the fuel cell stack 10, the vehicle speed, the power generation amount of the fuel cell stack 10, the temperature in the interior of the vehicle, and the outside air temperature. In additional, the controller 100 may be configured to collect information on a state of charge (SOC) of a high-voltage battery (not illustrated) mounted in the vehicle (S100).

The controller 100 may be configured to calculate the available heating power on the basis of a target interior temperature set by the user. The available heating power may mean electric power that may be used to operate the fuel cell stack 10, the COD heater 30, and the heater core 40 in the heating mode of the fuel cell thermal management system 1 (S200).

The controller 100 may be configured to compare the current interior temperature of the vehicle with the target temperature. When the current interior temperature is equal to or higher than the target temperature, the controller 100 may be configured to end the heating mode of the fuel cell thermal management system 1. In this case, the controller 100 may be configured to end the heating process by stopping the operations of the heater core 40 and the blower (not illustrated) which are used to perform air conditioning and heating. The controller 100 may be configured to perform a fuel economy optimizing mode capable of maximally preserving electric power generated in the fuel cell stack 10 by stopping the operation of the COD heater 30 (S300 and S400).

When the current interior temperature is lower than the target temperature, the controller 100 may be configured to determine whether the temperature at the inlet of the fuel cell stack 10 is increased. The controller 100 may be configured to monitor a temperature at the inlet of the fuel cell stack 10 by using the second temperature sensor 14. Specifically, the controller 100 may be configured to compare the temperature at the inlet of the fuel cell stack 10 with a preset temperature. This is because the performance of the heater core 40 using the waste heat of the coolant in the fuel cell stack 10 is affected by the temperature of the coolant having passed through the fuel cell stack 10. The heating amount increases as the temperature of the coolant having passed through the fuel cell stack 10 increases. Therefore, in a state in which the temperature at the inlet of the fuel cell stack 10 is not increased, the effect of assisting in heating the vehicle interior by using the COD heater 30 may be low even though the rotational speed of the blower (not illustrated) is increased (S500).

When the temperature at the inlet of the fuel cell stack 10 is equal to or higher than the preset temperature, the controller 100 may be configured to increase the temperature of the coolant by controlling the COD heater 30. In this case, the controller 100 may not be configured to control the power generation amount of the fuel cell stack 10. Since the temperature at the inlet of the fuel cell stack 10 is equal to or higher than the preset temperature, the controller 100 may not need to increase the temperature of the coolant to be discharged from the fuel cell stack 10 by controlling the power generation amount of the fuel cell stack 10 (S600).

When the temperature at the inlet of the fuel cell stack 10 is lower than the preset temperature, the controller 100 may be configured to increase the temperature of the coolant by controlling the COD heater 30. In addition, the controller 100 may be configured to increase the temperature of the coolant to be discharged from the fuel cell stack 10 by performing control to allow the fuel cell stack 10 to generate the exceeding amount of electric power exceeding the preset amount of electric power (S700).

The temperature of the coolant may be increased by the operations of the COD heater 30 and the fuel cell stack 10 that generates the amount of electric power exceeding the preset amount of electric power. The coolant with the increased temperature may be introduced into the heater core 40. Therefore, the heating amount by the heater core 40 may increase (S800).

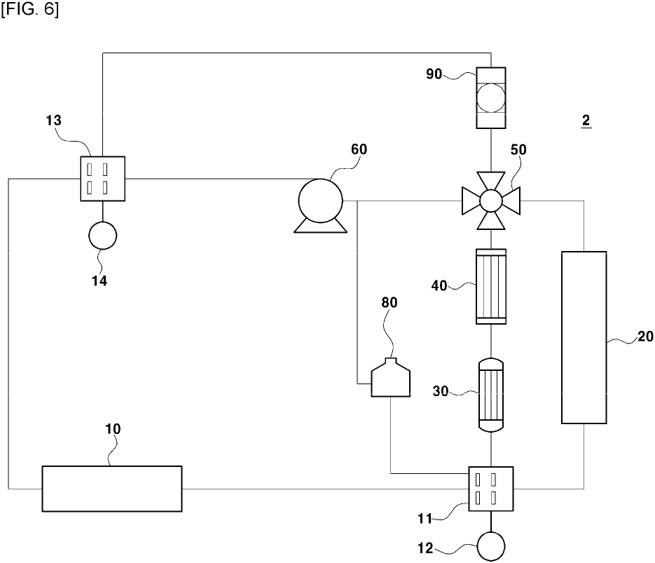

FIG. 6 is a view illustrating a modified example of the fuel cell thermal management system according to the embodiment of the present disclosure. For simplifying the description, a description of the contents identical to the contents described above will be omitted.

Referring to FIG. 6, the fuel cell thermal management system 2 may be configured to control the flow of the coolant by using a single 4-way valve. That is, the temperature adjustment valve 50 may be 4-way valve. The temperature adjustment valve 50 may be configured to provide the coolant supply pump 60 with the coolant introduced from the radiator 20 or the heater core 40. The coolant supply pump 60 may be configured to supply the coolant to the inlet manifold 13 of the fuel cell stack 10. The inlet manifold 13 may be configured to allow the supplied coolant to flow to the fuel cell stack 10 or the ion filter 90. That is, the ion filter 90 may be disposed on a line that connects the temperature adjustment valve 50 and the inlet manifold 13 of the fuel cell stack 10. The temperature adjustment valve 50 may be configured to control the coolant to be introduced into the ion filter 90 by opening or closing the port coupled to the ion filter 90.

For example, in the cold start mode of the fuel cell thermal management system 2, the temperature adjustment valve 50 may be configured to prevent the coolant from flowing to the radiator 20, and the temperature adjustment valve 50 may be configured to allow the coolant to flow to the COD heater 30 and the ion filter 90. That is, the port of the temperature adjustment valve 50 coupled to the radiator 20 may be closed, and the port of the temperature adjustment valve 50 coupled to the COD heater 30 and the ion filter 90 may be opened.

For example, in the heating mode of the fuel cell thermal management system 2, the temperature adjustment valve 50 may be configured to prevent the coolant from flowing to the radiator 20, and the temperature adjustment valve 50 may be configured to allow the coolant to flow to the COD heater 30. The temperature adjustment valve 50 may be configured to allow the coolant discharged from the fuel cell stack 10 to flow into the COD heater 30 without a loss of the flow rate. That is, the port of the temperature adjustment valve 50 coupled to the radiator 20 and the ion filter 90 may be closed, and the port of the temperature adjustment valve 50 coupled to the COD heater 30 may be opened.

For example, in the high output mode of the fuel cell thermal management system 2, the temperature adjustment valve 50 may be configured to allow the coolant to flow to the radiator 20, and the temperature adjustment valve 50 may be configured to prevent the coolant from flowing to the COD heater 30. The temperature adjustment valve 50 may be configured to allow the coolant discharged from the fuel cell stack 10 to flow into the radiator 20 without a loss of the flow rate. That is, the port of the temperature adjustment valve 50 coupled to the COD heater 30 and the ion filter 90 may be closed, and the port of the temperature adjustment valve 50 coupled to the radiator 20 may be opened.

While the embodiments of the present disclosure have been described with reference to the accompanying drawings, those skilled in the art will understand that the present disclosure may be carried out in any other specific form without changing the technical spirit or an essential feature thereof. Therefore, it should be understood that the above-described embodiments are illustrative in all aspects and do not limit the present disclosure.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A structure for improving performance of a fuel cell thermal management system, the structure comprising:
a radiator configured to exchange heat with a coolant discharged from a fuel cell stack;
a coolant supply pump configured to supply the coolant to the fuel cell stack;
a cathode oxygen depletion (COD) heater disposed in parallel with the radiator;
a heater core disposed in series with the COD heater and configured to heat an interior of a vehicle;
a temperature adjustment valve coupled to the radiator, the coolant supply pump, and the heater core and configured to control a flow of the coolant; and
a reservoir disposed between a downstream side of the fuel cell stack and a front end of the coolant supply pump and configured to adjust a pressure of the coolant.

2. The structure of claim 1, wherein the temperature adjustment valve is configured to:
restrict a flow of the coolant to the radiator; and
allow the coolant to flow to the COD heater and the heater core during a cold start of the fuel cell thermal management system.

3. The structure of claim 1, further comprising:
a stack bypass valve disposed between an upstream side of the fuel cell stack and the coolant supply pump; and
an ion filter disposed between the stack bypass valve and the downstream side of the fuel cell stack.

4. The structure of claim 3, wherein the stack bypass valve is configured to:
prevent the coolant from flowing to the fuel cell stack; and
allow the coolant to flow to the ion filter during a cold start of the fuel cell thermal management system.

5. The structure of claim 3, wherein the stack bypass valve is configured to prevent the coolant from flowing to the ion filter in a heating mode of the fuel cell thermal management system.

6. The structure of claim 1, wherein the temperature adjustment valve is configured to:
prevent the coolant discharged from the fuel cell stack to flow to the heater core and the COD heater; and
allow the coolant to flow to the radiator in a high output mode of the fuel cell thermal management system.

7. The structure of claim 1, wherein a part of the coolant discharged from the fuel cell stack flows to the reservoir at normal times.

8. The structure of claim 1, wherein the temperature adjustment valve is configured to:
prevent the coolant from flowing to the radiator; and
allow the coolant discharged from the fuel cell stack to flow to the COD heater and the heater core in a heating mode of the fuel cell thermal management system.

9. The structure of claim 1, further comprising a controller configured to calculate available heating power in a heating mode of the fuel cell thermal management system based on a target temperature of the interior of the vehicle inputted by a user and a temperature measured by temperature sensors respectively disposed at upstream and downstream sides of the fuel cell stack.

10. The structure of claim 9, wherein the controller is configured to:
compare a current temperature of the interior of the vehicle with the target temperature; and
when the current temperature of the interior is equal to or higher than the target temperature, end the heating mode of the fuel cell thermal management system by stopping operations of the COD heater and the heater core.

11. The structure of claim 9, wherein:
when a current temperature of the interior of the vehicle is lower than the target temperature, the controller is configured to monitor a temperature at an inlet of the fuel cell stack, and
when the temperature at the inlet of the fuel cell stack is equal to or higher than a preset temperature, the controller is configured to increase a temperature of the coolant by controlling the COD heater.

12. The structure of claim 11, wherein the controller is configured to increase the temperature of the coolant to be discharged from the fuel cell stack by controlling the fuel cell stack to generate an exceeding amount of electric power.

13. The structure of claim 1, further comprising an ion filter disposed on a line branching off between an upstream side of the fuel cell stack and the coolant supply pump and coupled to the temperature adjustment valve.

14. The structure of claim 13, wherein:
an inlet manifold is disposed at the upstream side of the fuel cell stack;
an outlet manifold is disposed at a downstream side of the fuel cell stack; and
the inlet manifold is configured to distribute the coolant, which is supplied from the coolant supply pump, to the ion filter or the fuel cell stack.

15. The structure of claim 1, wherein:
an inlet manifold is disposed at an upstream side of the fuel cell stack;
an outlet manifold is disposed at a downstream side of the fuel cell stack; and
the outlet manifold distributes the coolant to the reservoir, the COD heater, and the radiator.
